(19) United States
(12) Patent Application Publication
(10) Pub. No.: US 2007/0062812 A1
(43) Pub. Date: Mar. 22, 2007

(54) Gas sensor and method for the production thereof

(76) Inventors: Heribert Weber, Nuertingen (DE); Odd-Axel Pruetz, Nuertingen (DE); Christian Krummel, Kirchentellnsfurt (DE); Christoph Schelling, Reutlingen (DE); Detlef Gruen, Reutlingen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/565,991

(22) PCT Filed: Jul. 23, 2004
(86) PCT No.: PCT/DE04/01645

§ 371 Date: Jul. 6, 2006

(30) Foreign Application Priority Data
Jul. 25, 2003 (DE) 10333996.5
Oct. 13, 2003 (DE) 10347416.1

(51) Int. Cl. G01N 27/26

(52) U.S. Cl. 204/431

(57) ABSTRACT

The invention relates to a gas sensor comprising a membrane layer (3) formed on a semiconductor substrate (2), an evaluation structure (7) being arranged on said substrate in an evaluation area (8) and a heating structure (9) outside the evaluation area (8), in addition to a gas-sensitive layer (10) arranged above the evaluation structure (7) and the heating structure (9), wherein said gas-sensitive layer (10) can be heated by the heating structure (9) and the electrical resistance of the gas-sensitive layer (10) can be evaluated by the evaluation structure (7). The heating structure (9) is arranged on an adhesion-promoting oxide layer (6) on the top surface of the membrane layer (3) and is separated from the gas-sensitive layer by a cover oxide layer (11). In order to enable reliable functionality of the gas sensor, that in the evaluation area (8), an adhesion-promoting layer (13) insensitive to oxide etching is arranged between the membrane layer (3) and the evaluation structure (7) or the evaluation structure (7) in the evaluation area (8) corresponding to the heating structure (9) is separated from the gas-sensitive layer (10) by the cover oxide layer (11), wherein the cover oxide layer (11) has contact holes (12) which uncover a central area of the surface of the evaluation structure (7) in order to produce a direct contact between the evaluation structure (7) and the gas-sensitive layer (10).

The present invention relates to a gas sensor and a method of making same.

Semiconductor gas sensors are known in various configurations for gas detection. These gas sensors are used in safety systems in industry and in the last several years increasingly in the automotive field where gas sensors are employed for example for the automatic control of ventilation flaps to prevent the incursion of toxic gases into the vehicle interior.

The known gas sensors have a gas sensitive layer which, upon contact with reducing or oxidizing gases, undergoes a change in the surface conductivity and thus the electrical resistance. These resistance changes are evaluated by means of a suitable evaluation or electrode structure for measured signals. The operating temperature of such gas sensors, which can amount for example to several hundred ° C., are produced by an integrated heating structure which is frequently in the form of a meander. To set the operating temperature of the gas sensor and to monitor it, at least one temperature measurement resistance is provided in the region of the heating structure.

The gas sensitive layer comprises as a rule a semiconductive metal oxide like SnO₂ or WO₃. The selectivity for individual gases is enabled by a doping of the gas sensitive layer with corresponding doping materials and by the choice of the operating temperature.

Since the specific resistance of the gas sensitive layer is very high, the evaluating or electrode structure as a rule is comprised of an interdigital structure (IDT; Interdigitated Transducer) which comprises two coplanar, comb-shaped or finger like electrodes which interdigitate with one another. This configuration corresponds to a parallel circuit of resistances between the individual fingers of different polarity which results in a decreased measurement resistance and an increase in the sensitivity of the gas sensor.

Many of the known gas sensors are micromechanically constructed on the basis of membrane sensors with a semiconductive substrate. Because of the arrangement of the heating structure, evaluating or electrode structure and the gas sensitivity layer on a membrane, the thermal capacity of the system is reduced which brings about a reduction in the power consumption of the gas sensor.

In the production of such gas sensors, initially the heating structure, the evaluating structure [electrode structure] and optionally a temperature measurement resistance in the region of the heating structure are applied to the membrane. The upper side of the membrane is formed with an adhesion promoting layer, as a rule an oxide layer, in order to insure effective adhesion of these structures to the membrane. Then, a cover oxide layer is deposited and by an oxide etching with the aid of an etching solution is removed on a wide area basis in the region of the evaluating structure up to the surface of the evaluating structure and the gas sensitive layer is applied thereto.

In order to insure that the entire surface of the evaluating structure has been freed from the covered oxide and can provide a full-surface contact with the gas sensitive layer, the oxide etching of the cover oxide is carried out as a rule for an excess etching. In that case, however, there is the danger that an unetching of the evaluation structure can arise in which the etched solution can etch away the oxide of the adhesion promoting oxide layer even below the evaluation structure and even without this layer in part. This can result in a reduction in the adhesion of the evaluation or electrode structure to the membrane so that the evaluation or electrode structure in the course of the life of the gas sensor will partly separate from the membrane and such that its reliability can no longer be insured.

A further problem which can arise is that the resistance value of the evaluating or electrode structure and especially that of the heating structure can vary over the life of the sensor. This detrimental affect on the gas sensor is referred to as electrical “drift” and can be the result of a thermal stressing since the gas sensor in operation is permanently cycled between two working temperatures. This can lead to material transformations within the structure, for example, to a migration of grain boundaries or a growth of crystallites which are connected with resistance changes. The electrical drift arises especially with gas sensors used in the automotive field since here there is a sharply varying change in temperature between for example −30° to +150° C., depending upon gas sensor applications and which contributes to additional thermal loading.

With respect to the evaluation or electrode structure which measures very high resistance values (in the MΩ range), the resistance variation may be negligible. For the heating structure, however, the resistance variation gives rise to a variation in the heating power and thus the operating temperature of the gas sensor. The same applies to the temperature measuring resistance which suffers changes and is located in the region of the heating structure so that the exact temperature of the gas sensor may no longer be determinable.

As a consequence, the electrical draft represents a limitation on reliable and stable functioning over the life of the gas sensor. The gas sensors can, of course, be replaced at certain time intervals or calibrated, but these solutions are associated with very high cost. Especially in the automotive field, this approach is not practical.

The object of the present invention is to provide an improved gas sensor which is characterized by a reliable function and a corresponding method of making it.

This object is achieved with a gas sensor according to claims 1 or 3 or by a method according to claims 10 or 12. Further advantageous embodiments are given in the dependent claims.

According to the invention, a gas sensor of the type described at the outset having a membrane layer formed on a semiconductor substrate and upon which a metallic evaluating or electrode structure is arranged in an evaluating region and a metallic heating structure is arranged outside the evaluating region and having a gas sensitive layer arranged above the evaluating or electrode structure and the heating structure and in which the heating structure is provided on an adhesion promoting oxide layer on the surface of the membrane layer and is separated from the gas sensitive layer by a cover oxide layer, is formed in the evaluating region with an adhesion promoting layer between the membrane layer and the evaluating or electrode structure which is insensitive to oxide etching. By the use of this latter adhesion promoting layer in the evaluating region instead of the conventional adhesion promoting oxide layer, the danger of underetching of the evaluating or electrode structure during the oxide etching of the cover oxide layer is avoided during the production of the gas sensor and a permanent adhesion of the evaluating or electrode structure to the membrane layer and thus reliable functioning of the gas sensor is insured. In an embodiment relevant to actual practice, the adhesion promoting layer is structured in correspondence with the evaluating or electrode structure to suppress detrimental parallel parasitic or surface currents over the adhesion promoting layer which, for example, can arise with semiconductive adhesion promoting layers.

According to the invention, in addition, a gas sensor having a membrane layer formed on the semiconductor substrate and on which a metallic evaluating or electrode structure is arranged in an evaluating region and a metallic heating structure is arranged outside the evaluating region and a gas sensitive layer is arranged above the evaluating or electrode structure and the heating structure and in which the heating structure is disposed on an adhesion promoting oxide layer on the surface of the membrane layer and is separated by a cover oxide layer from the gas sensitive layer, has the evaluating or electrode structure in the evaluating region, like the heating structure, separated from the gas sensitive layer by the cover oxide layer provided with contact holes which leave respective intermediate regions of the surface of the evaluating or electrode structure free so that a direct contact can be formed between the evaluating structure or electrode structure and the gas sensitive layer.

This construction of a gas sensor as well insures reliable functioning since, in the production of the gas sensor, contact holes are etched in the cover oxide layer which respectively only expose a central region of the surface of the evaluating or electrode structure so that the adhesion promoting oxide layer beneath the evaluating structure is not attacked during the oxide etching of the covered oxide layer and thus insure the effective bonding of the evaluating structure to the membrane layer.

Since the applied gas sensitive layer undergoes in the production of the gas sensor a sintering process and as a result especially at transition regions between the surface of the evaluating or electrode structure covered by the cover oxide layer and the surfaces exposed through the contact holes, different thermomechanical stresses can arise which can result in transformation of material within the evaluating or electrode structure or even a partial tearing apart of the evaluating or electrode structure, the cover layer in a preferred embodiment is comprised of a stoichiometric oxide at least in the evaluating region of the evaluating structure. This stoichiometric oxide, which has a poorer bond to the evaluating structure than one with a reduced oxygen component and thus a substoichiometric oxide, couples reduced thermal stresses into the evaluating structure and thus affords a greater mobility so that material transformations within the evaluating or electrode structure have less effect during sintering processes than would otherwise be the case.

According to a further highly preferred embodiment, the cover oxide layer is comprised at least in the region of the heating structure and of the optional temperature measurement resistance, of a substoichiometric oxide to produce a relatively good bond of the cover oxide layer to the heating structure and the temperature measuring resistance. As a result, the problem attacked above of the electrical drift of the heating structure and the temperature measuring resistance, is resolved in that the material transformations resulting from the thermal stress effects in operation of the gas sensor within the heating structure and the temperature measuring resistance are suppressed to enable a stable functioning over the life of the gas sensor.

According to a further aspect of the invention, a method of making a gas sensor is provided in which initially a semiconductor substrate is prepared and a membrane layer is formed on its front side and then a bond promoting oxide layer is deposited on the surface of the membrane layer. Thereafter, the bond promoting oxide layer is structured in order to provide an oxide free evaluation region on the membrane. Thereafter, a bond promoting layer which is not sensitive to oxide etching is applied to the front side of the semiconductor substrate and is removed outside the evaluation region. In a following step, the metallization layer is applied to the front side of the semiconductor substrate which outside the evaluation region on the adhesion promoting oxide layer is structured into a heating structure and in the evaluation region on the bond promoting layer is structured into an evaluating structure or electrode structure. Subsequently, a cover oxide layer is applied to the front side of the semiconductor substrate and this is etched in the evaluation region on an area-wide basis in order to expose the surface of the evaluating structure. Thereafter, the backside of the semiconductive substrate is etched until the membrane layer is reached and then, finally, a gas sensitive layer is applied to the front side of the semiconductor substrate.

With the aid of this method, the above described gas sensor with an adhesion promoting layer in the evaluation region can be made. With the additional adhesion promoting layer, an underetching of the evaluating or electrode structure is avoided during the oxide etching of the oxide cover layer so that a permanent adhesion of the electrode structure to the membrane layer and thus reliable functioning of the gas sensor can be insured.

According to the invention, the method for making a gas sensor provides further that, at the beginning, a semiconductor substrate is prepared and on the front side of this semiconductor substrate a membrane layer is deposited and then configured with an adhesion promoting oxide layer on the outer surface of the membrane layer. Then, a metallization layer is applied to the adhesion promoting oxide layer and this metallization layer is then structured to form a heating structure and an evaluating or electrode structure. In the next step, a cover oxide layer is applied to the front side of the semiconductor substrate. Thereafter, contact holes are etched in the cover oxide layer to expose central regions of the surface of the evaluating or electrode structure. Thereafter, the backside of the semiconductor substrate can be etched away to reach the membrane layer and then a gas sensitive layer can be applied to the front side of the semiconductor substrate. This method enables the production of the above described gas sensor with contact holes in the cover oxide layer. Since the contact holes are so etched that these only expose central or intermediate regions of the surface of the evaluating or electrode structure and the lateral regions of the evaluating or electrode structure remain covered by the cover oxide layer, an etching at the underside of the evaluating or electrode structure where the bond promoting oxide layer is provided can be avoided, guaranteeing an effective bond of the evaluating structure to the membrane layer and thus reliable functioning of the gas sensor.

In a preferred embodiment, the gas sensitive layer is applied in a paste form and then sintered. Various doping agents can be introduced into the gas sensitive layer while it is initially in its paste form in order to adjust the selectivity of the sensor for different gases.

The invention is described in greater detail in connection with the figures. They show:

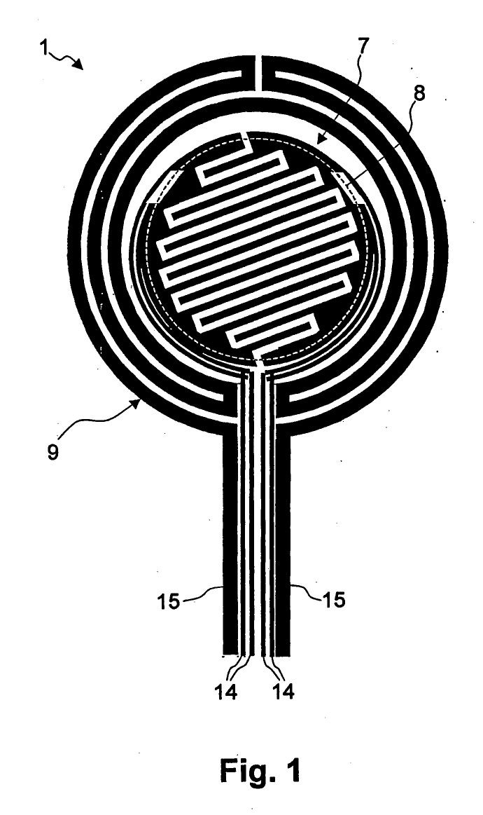

FIG. 1 a schematic illustration of the gas sensor in a plan view.

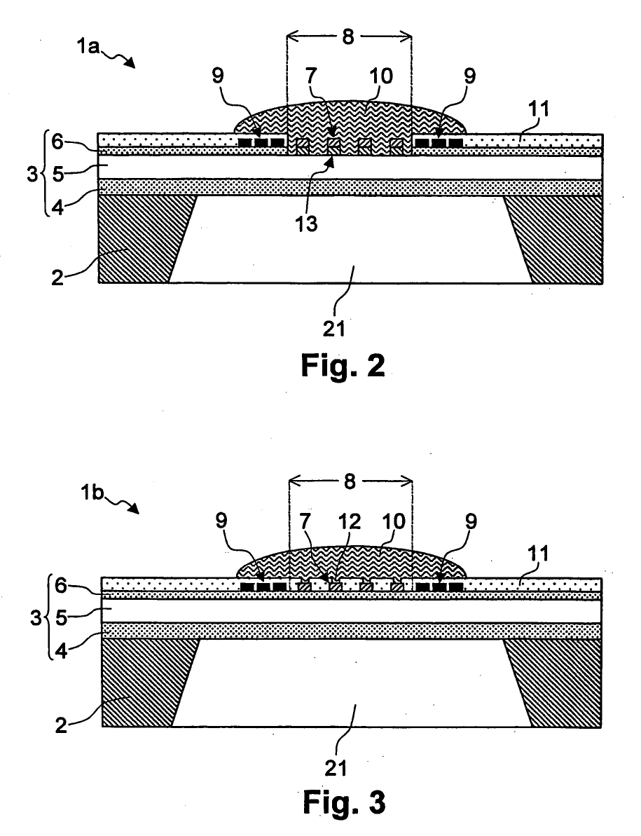

FIG. 2 a cross section of a first embodiment of the gas sensor according to the invention.

FIG. 3 a cross section of a second embodiment of a gas sensor according to the invention, and

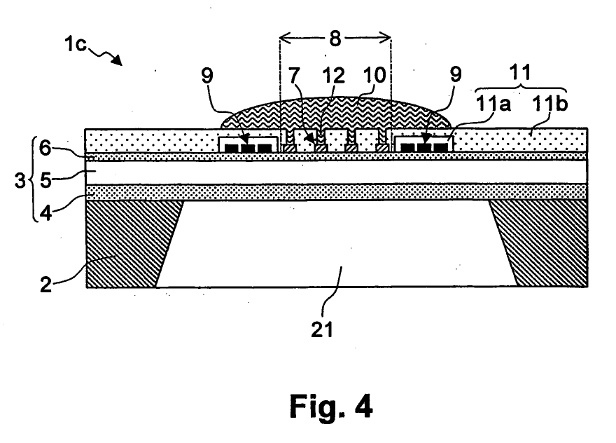

FIG. 4 a cross section of a third embodiment of a gas sensor according to the invention.

FIG. 1 shows a schematic illustration of the structure of a gas sensor 1 known from the state of the art in a plan view. The gas sensor 1 has toward the outside, a substantially circular meander-shaped metallic heating structure 9 which can be supplied with electrical energy by the feed lines 15. Within the heating structure is a metallic evaluating or electrode structure 7 of generally circular shape and which is also provided with electrical leads 14. These structures 7 and 9 are arranged on a membrane layer (not shown) on a semiconductor substrate whereby the heat capacity of the entire system and thus the power requirement of the gas sensor 1 is reduced.

On the heating structure 9 and the evaluating structure 7 a gas sensitive layer not shown in FIG. 1 is applied and which substantially covers the entire area delimited as the heating structure 9. The gas sensitive layer which can be brought to an operating temperature by the heating structure 9 of several hundred degrees Celsius, changes its resistance when contacted by reducing or oxidizing gases. This resistance change is evaluated as a measured change by the evaluation structure 7. Since the gas sensitive layer 7 as a rule has a very high resistance, the evaluating structure 7 is configured as an interdigital structure with two coplanar finger like electrodes interdigitating with one another. This configuration corresponds to a parallel structure of the resistances between the individual electrode fingers of different polarity whereby the measurement resistance of the gas layer is reduced and the sensitivity of the gas sensor 1 is increased.

To assure sufficient adhesion of the heating structure 9, 5, the evaluating structure 7 and the feed lines 14, 15 to the membrane layer, the surface of the membrane layer is provided with an adhesion promoting oxide layer.

To insulate the heating structure 9, between the heating structure 9 and the gas sensitive layer, a cover oxide layer is formed which extends further also over the feed lines 14, 15 to the contact or bonding surfaces of the feed lines 14 and 15 which have not been shown. In the production of the gas sensor, these cover oxide layers as a rule are applied on a wide area basis in a CVD deposition process (CVD=Chemical Vapor Deposition) to the heating structure 9 and the evaluating structure 7 thereby are already structured on the membrane layer, as well as to the feed lines 14, 15. Thereafter the cover oxide layer 8 is removed on a wide area basis from the entire upper surface of the evaluating structure 7 as indicated by the broken line circle in FIG. 1 to enable a contact of evaluating or electrode structure 7 with the later applied gas sensitive layer.

The removal is effected as a rule by a wet chemical etching process in which for example hydrofluoric acid can be used as the etching solution. Since the cover oxide layer can have different thicknesses at different locations because of deposition inhomogeneity, the etching process is carried out for a super etching interval in order to ensure that the entire surface of the evaluating or electrode 7 will be exposed in the evaluating region 8 devoid of the cover oxide.

The use of a superetching duration creates however a danger of underetching the evaluating or electrode structure 7 since the etching solution used can reach the region between the electrode fingers of the adhesion promoting oxide layer below the evaluating structure and attack this layer in part. As a result the adhesion of the evaluating structure 7 to the membrane layer is reduced so that the evaluating structure 7 in the course of the use of the gas sensor can separate therefrom so that reliable functioning of the gas sensor can no longer be assured. To avoid the danger of underetching of the evaluating or electrode 7 various embodiments of a gas sensor can be provided according to the invention as described in greater detail with respect to the following figures.

FIG. 2 shows a cross section of a first embodiment of a gas sensor according to the invention. The gas sensor 1a comprises for example a semiconductor substrate 2 which can be comprised of silicon and which is recessed at 21 and on which a membrane layer 3 is formed. The membrane layer 3 is a layer sequence of an oxide layer 4 bonded to the semiconductor substrate and a nitride layer 5 and has, outside an evaluating region 8 on the surface of the membrane an adhesion promoting oxide layer 6. On the adhesion promoting oxide layer 6 a metallic heating structure 9 and a temperature measuring resistance in the region of the heating structure, but not shown in FIG. 2, are arranged. On the heating structure 9 and the temperature measuring resistance, there is provided, further a cover oxide layer 11 for insulation. Within the evaluating region 8, a metallic evaluating or electrode structure 7 with fingers interdigitating with one another, can be provided. On these structures a gas sensitive layer 20 is applied and can be heated by the heating structure 9 and its electrical resistance evaluated by the evaluating or electrode structure 7. With the aid of the temperature measuring resistance and a reference resistance also not shown in FIG. 2 and arranged on the massive structure 2, the operating temperature of the gas sensor 1 can be monitored.

As material for the metallic structures, the evaluation structure on electrode structure 7, the heating structure 9 and the temperature measuring resistance, preferably platinum is used. This material is characterized by a high temperature coefficient of the resistance which on the one hand allows good adjustment of the heating power of the heating structure 9 and also the temperature of the gas sensor 1a to be measurable via the temperature measuring resistance with high precision. In addition, in platinum one has an inert material with a high chemical stability.

By contrast with a gas sensor known from the state of the art, the evaluating or electrode structure 7 is disposed on an adhesion promoting layer 13 which is not sensitive to oxide etching, i.e., is unaffected by oxide etching. This adhesion promoting layer 13 which, for example, is comprised of silicon, is structured to correspond to the evaluating or electrode structure 7 to avoid detrimental surface leakage currents between the individual electrode fingers of the evaluating or electrode structure 7. The advantageous effect of the adhesion promoting layer 13 will be explained in connection with the following description of the fabrication process of this gas sensor 1a in accordance with the invention. To begin, the semiconductor substrate 2 will be prepared and on its front side provided with the oxide layer 4 and the nitride layer 5 to form the membrane layer 3. The oxide layer 4 can for example be produced by a thermal oxidation of the semiconductor wafer 2 and the nitride layer 5 deposited with the aid of a CVD (chemical vapor deposition). Then the adhesion promoting oxide layer 6 is formed over the entire area of the upper side of the membrane layer 3, possibly through a reoxidation of the nitride layer 5 effected by thermal conversion or by a CVD oxidation deposition.

The adhesion promoting oxide layer 6 is then subjected to structuring by means of an oxide etching which provides an oxide free evaluating region 8 on the membrane layer 3. In the next step an adhesion promoting layer 13 which is not sensitive to oxide etching, i.e. is not removed by an oxide etching solution, is applied over the entire are of the evaluating region 8 on the front side of the semiconductor substrate 2 and is structured corresponding to the later formed evaluating or electrode structure 7, for example with the aid of an ion beam etching process.

Subsequently, a metallization layer is applied over the entire area to the front side of the semiconductor substrate 2 and in this metallization layer the heating structure 9, and the temperature measuring resistance outside the evaluating region 8 are structured and the evaluating or electrode structure 7 within the evaluating region 8 is structured. This structuring can also be carried out by means of an ion beam etching process. Thereafter the cover oxide layer 11 is applied by a CVD coating process over the entire area to the front side of the semiconductor substrate 2. In order to expose the surfaces of the evaluating or electrode structure 7, the cover oxide layer 11 is subjected to removal by a wet chemical etching process, for example with a hydrogen fluoride etching solution which is applied on an area wide basis in the evaluating region 8.

Since the evaluating or electrode structure 7 is disposed on the adhesion promoting 13 which is not sensitive to this oxide etching, the danger of underetching of the evaluating structure or electrode structure 7 is avoided. In addition, no underetching of the adhesion promoting layer 13 can arise when, as illustrated in FIG. 2, the entire cover oxide layer 11 is etched away up to the nitride layer 5 of the membrane layer 3 since the nitride layer 5 is also insensitive to the wet chemical oxide etching. The use of the adhesion promoting layer 13 ensures a secure adhesion of the evaluating of electrode 7 to the membrane layer 3 and thus a reliable functioning of the gas sensor 1a. In a subsequent method step, the semiconductor substrate 2 is etched away at its backside for example with the aid of a potassium hydroxide solution until the membrane layer 3 is formed, thereby forming the recess 21. The oxide layer 4 which has a greatly reduced etching rate by comparison with that of the semiconductor 2 functions in this case as an etch stop at which the etching process can be terminated.

Finally the gas sensitive layer 10 is produced on the front side of the semiconductor substrate 2. The gas sensitive layer 10 is initially applied in a paste form, especially with silk screening or dispenser application and is then sintered. The gas sensitive layer 10 can include doping agents which can make the gas sensor 1a sensitive to the detection of specific gases. It is also possible to apply the gas sensitive layer by sputtering processes or CVD processes and optionally to sinter it.

Alternatively, it is possible to vary the aforedescribed method according to the invention for making the gas sensor 1a of the invention and illustrated in FIG. 2. For example, it is possible to remove the whole-area adhesion promoting layer 13 which is applied on the front side of the semiconductor substrate 2 initially only outside the evaluation region 8 and then to structure it simultaneously with the evaluating or electrode structure 7. Also it is possible to apply the gas sensitive layer 10 before the backside etching of the semiconductor 2 as long as the gas sensitive layer 10 is securely protected against etching attack.

The known problem of the state of the art of underetching the evaluating or electrode structure 7 during the fabrication process can also be avoided with a second embodiment of a gas sensor according to the invention illustrated in FIG. 3. With this gas sensor 1b, differing from the gas sensor 1a illustrated in FIG. 2, the adhesion promoting oxide layer 6 on the surface of the membrane layer 3 is not structured and is located in the evaluating region 8 below the evaluating or electrode structure 7. The cover oxide layer 11 also extends over the evaluating region 8 and has contact holes 12 which expose respectively only an intermediate region of the surface of the evaluating or electrode structure 7. In the production of this gas sensor 1b, after the application of the membrane layer 3 formed from the oxide layer 4 ad the nitride layer 5 on the prepared semiconductor substrate and after the deposition of the band promoting oxide layer 6 on the upper side of the membrane layer 3 a metallizing layer is deposited and structured correspondingly to form the heating structure 9, the evaluating structure 7 and the temperature measuring resistance.

Thereafter the cover oxide layer 11 is deposited on the entire area of the front side of the semiconductor substrate 2. With the aid of a wet chemical etching process, the contact holes 12 are then etched in the cover oxide layer 11, these contact holes lying only in an intermediate region of the upper surface of the evaluating or electrode structure 7 so that only this region is exposed and so that the surfaces of the electrode fingers of the evaluating or electrode structure on their sides remain covered with the cover oxide layer 11. In this manner the oxide etching solution cannot attack the adhesion promoting oxide layer 6 below the evaluating or electrode structure 7 so that a reliable evaluating or electrode structure is formed on the membrane layer 3. Thereafter, the backside etching of the semiconductor substrate 2 is carried out on the gas sensor 1b and the application of the gas sensitive layer to the front side of the semiconductor substrate is carried out so that the gas sensitive layer 10 will also be received in the contact holes 12.

The gas sensor 1b according to the invention as shown in FIG. 3 has the drawback with respect to the gas sensor 1a illustrated in accordance with the invention in FIG. 2 that because of the tolerances between the masks required for the structuring of the evaluating structure 7 and for the etching of the contact holes only large spacings can be provided between the individual electrode fingers. The gas sensor 1b will be less sensitive since the greater the spacing between the individual electrode fingers, the greater will be the measurement resistance. On the one hand the resistance which is length dependent and measured between the electrode fingers will be greater while on the other hand fewer electrode fingers and thus fewer parallel circuits can be provided on a given area.

The problem of the electrical drift is the consequence of a thermomechanical stress effect since the gas sensors 1a, 1b in operation, work in a permanent cycling between ambient temperature and operating temperature which can give rise to a transformation of material within the metallic structures contributing to resistance changes.

With the evaluating structure or electrode structure 7, the resulting resistance changes can be negligible because of the high measurement resistance of the gas sensitive layer 10. With the heating structure 9, however, which has a resistance which especially can lie in the ohm range, the resistance change gives rise to a significant alteration of the heating power and thus the operating temperature of the gas sensor 1a or 1b. This also applies to the temperature measuring resistance which is arranged in the means of the heating structure 9 so that the exact temperature of the gas sensor 1a or 1b may no longer be determined and such that a reliable and stable functioning cannot be ensured over the life of the gas sensor 1a, 1b.

The problem of electrical drift is largely suppressed in the third embodiment of the invention illustrated in FIG. 4 and which is based upon the embodiment illustrated in FIG. 3.

With this gas sensor 1c, a two layer cover oxide layer 11 is used which in the region of the drift sensitive heating structure the temperature measurement resistance and its electrical lines comprised of a substoichiometric oxide layer 11a and which in the case of a silicon cover oxide layer is also comprised of a silicon rich oxide on which a purely stoichiometric oxide layer 11b is arranged. This cover oxide layer 11 can for example be applied by whole surface deposition of the substoichiometric oxide layer 11a on the side of the membrane layer 3 with the already formed metallic structures including the substoichiometric oxide layer structuring and subsequent whole area deposition of the stoichiometric oxide layer 11b. The application of the two oxide layers 11a, 11b is possible with the aid of CVD deposition processes. The substoichiometric oxide layer 11a is characterized by a relatively good bond to the heating structure 9 and the temperature measuring resistance and material transformation because of thermal stress effects within the heating structure 9 and the temperature measuring resistance are largely suppressed. As a consequence, stable functioning over the life of the gas sensor 1c is possible.

The stoichiometric oxide layer 11b which is applied to the substoichiometric oxide layer 11a and the evaluating or electrode structure 7 and which as shown in the embodiment of FIG. 3 is provided with contact holes has been found to be highly advantageous for the evaluating or electrode structure 7 with a sintering process for the gas sensitive layer 10 because of the high temperatures arising in this process, at the transition regions between the surfaces of the evaluating or electrodes structure 10 cover by the oxide layer 11 and the surfaces which are exposed through the contact holes 12, different thermomechanical stresses arise which can induce material transformations within the evaluating or electrode structure 7. The stoichiometric oxide layer 11b which has a poorer adhesion to the evaluating structure than a layer comprised of a substoichiometric oxide couples a reduced thermal stress into the evaluating or electrode structure 7 so that material transformation in a sintering process within the evaluating structure 7 is less critical.

Instead of the described embodiments a gas sensor according to the invention can be provided in an embodiment which is a combination of the embodiments shown in FIGS. 2 to 4. For example in the gas sensor 1a shown in FIG. 2 the cover oxide layer 11 can be formed as a substoichiometric oxide layer in order to avoid the electrical drift by the heating structure 9 and the temperature measuring resistance.

As a general matter it is also sensible, with a gas sensor having metallic structures sensitive to drift, to cover them with a substoichiometric oxide layer and at the transition regions between covered and exposed surfaces of the structure to use a stoichiometric oxide to increase the stability on sintering. This applies as well for example also for the conductors of the metallic structures and with which the use of stoichiometric covering oxides bounding on the known covered contacting surfaces is advantageous.

The feature disclosed in FIG. 4, namely, the use of a substoichiometric oxide layer as a cover oxide layer for drift sensitive structures can also be employed as an independent feature of a gas sensor. It is possible to use this feature for other sensors as well like for example air mass sensors.

1. A gas sensor on a membrane layer (3) formed on a semiconductor substrate (2) on which a metallic evaluating or electrode structure (7) is arranged in an evaluating region (8) to a metallic heating structure (9) is arranged outside the evaluating region (8) and a gas sensor layer (10) disposed on the evaluating or electrode structure (7) and the heating structure (9), whereby the gas sensitive layer (10) is heatable by the heating structure (9) and the electrical resistance of the gas sensitive layer (10) is evaluatable by the evaluating and electrode structure (7) and whereby the heating structure (9) is disposed on an adhesion promoting oxide layer (6) on the upper side of the membrane layer (3) and is separated by a cover oxide layer (11) from the gas sensitive layer (10) characterized in that in the evaluating region (8) an adhesion promoting layer (13) which is not sensitive to an oxide etching is located between the membrane layer (3) and the evaluating or electrode structure (7).

2. The gas sensor according to claim 1 characterized in that the adhesion promoting layer (13) is structured correspondingly to the evaluating or electrode structure (7).

3. A gas sensor on a membrane layer (3) formed on a semiconductor substrate (2) on which a metallic evaluating or electrode structure (7) is arranged in an evaluating region (8) to a metallic heating structure (9) is arranged outside the evaluating region (8) and a gas sensor layer (10) disposed on the evaluating or electrode structure (7) and the heating structure (9), whereby the gas sensitive layer (10) is heatable by the heating structure (9) and the electrical resistance of the gas sensitive layer (10) is evaluatable by the evaluating and electrode structure (7) and whereby the heating structure (9) is disposed on an adhesion promoting oxide layer (6) on the upper side of the membrane layer (3) and is separated by a cover oxide layer (11) from the gas sensitive layer (10) characterized in that the evaluating or electrode structure (7) in the evaluating region (8) corresponding to the heating structure (9) is separated from the gas sensitive layer (10) by the cover oxide layer (11), whereby the cover oxide layer (11) has contact holes (12) which each respectively exposes an intermediate region of the surface of the evaluating or electrode structure (7) to enable a direct contact between the evaluating or electrode structure (7) and the gas sensitive layer (10) to be made.

4. The gas sensor according to claim 3 characterized in that the cover oxide layer (11) in the evaluating region (8) of the evaluating or electrode structure (7) is comprised of a stoichiometric oxide.

5. The gas sensor according to claim 1 characterized in that the cover oxide layer (11a) at least in the region of the heating structure (9) is comprised of a substoichiometric oxide in order to produce a relatively good bond of the cover oxide layer (11) to the heating structure (9).

6. The gas sensor according to claim 1 characterized in that the membrane layer (3) is comprised of a nitride layer (5) which preferably has an oxide layer (4) bounding on the semiconductor substrate (2).

7. The gas sensor according to claim 1 characterized in that a temperature measurement resistance is provided on the adhesion promoting oxide layer (6) in the region of the heating structure (9).

8. The gas sensor according to claim 1 characterized in that the evaluating or electrode structure (7) the heating structure (9) and the temperature measurement resistance are comprised of the same metallic material, preferably platinum.

9. The gas sensor according to claim 1, characterized in that the evaluating or electrode structure (7) is configured as an interdigital structure with two coplanar finger-like electrodes interdigitating with one another.

10. A method of producing a gas sensor characterized by the following method steps:
(a) preparing a semiconductor substrate (2);
(b) providing a membrane layer (3) on a front side of the semiconductor substrate (2);
(c) depositing an adhesion promoting oxide layer (6) on the upper side of the membrane layer (3);
(d) structuring the adhesion promoting oxide layer (6) in order to prepare an oxide free evaluating region (8) on the membrane layer (3);
(e) applying an adhesion promoting layer (13) which is not sensitive to an oxide etching on the front side of the semiconductor substrate (2);
(f) removing the adhesion promoting layer (13) outside the evaluating region (8);
(g) applying a metallization layer on the front side of the semiconductor substrate (2);
(h) structuring a heating structure outside the evaluating region 8 on the adhesion promoting oxide layer (6) and an evaluating or electrode structure (7) in the evaluating region (8) on the adhesion promoting layer (13);
(i) applying a cover oxide layer (11) to the front sides of the semiconductor (2);
(j) carrying out a wide area oxide etching of the cover oxide layer (11) in the evaluating region (8) to expose the surface of the evaluating or electrode structure (7);
(k) etching the back side of the semiconductor substrate (2) until the membrane layer (3) is reached; and
(l) applying a gas sensitive layer (10) to the front side of the semiconductor substrate (2).

11. The method according to claim 10 characterized in that the adhesion promoting layer (13) is additionally structured corresponding to the structuring of the evaluating or electrode structure.

12. A method of producing a gas sensor characterized by the following method steps:
(a) preparing a semiconductor substrate (2);
(b) providing a membrane layer (3) on a front side of the semiconductor substrate (2);
(c) depositing an adhesion promoting oxide layer (6) on the upper side of the membrane layer (3);
(d) applying a metallization layer to the adhesion promoting oxide layer (6);
(e) structuring a heating structure (9) and an evaluating or electrode structure (7) in the metallization layer;
(f) applying a cover oxide layer to the front side of the semiconductor substrate (2);
(g) carrying out an oxide etching of contact holes (12) in the cover oxide layer (11) to expose respective central region of the surface of the evaluating or electrode structure (7);
(h) etching the back side of the semiconductor substrate (2) until the membrane layer (3) is reached; and
(I) applying a gas sensitive layer (10) to the front side of the semiconductor substrate.

13. The method according to claim 12 characterized in that the cover oxide layer (11) at least in the evaluating region (8) is comprised of a substoichiometric oxide layer (11b).

14. The method according to claim 10 characterized in that the cover oxide layer (11) is comprised at least in the region of the heating structure (9) of a substoichiometric oxide layer 11a to produce a relatively good bond of the cover oxide layer 11 to the heating structure (9).

15. The method according to claim 10 characterized in that the membrane layer (3) is formed from a nitride layer (5) which preferably is applied to an oxide layer 4 bounding on the semiconductor substrate (2).

16. The method according to claim 10 characterized in that a temperature measuring resistance is structured on the adhesion promoting oxide layer (6) in the region of the heating structure (9).

17. The method according to claim 10 characterized in that the gas sensitive layer (10) is applied in a paste form and is then sintered.

18. The method according to claim 10 characterized in that the gas sensitive layer is applied by sputtering or a CVD process and optionally is sintered.
